(19) United States
(12) Patent Application Publication
(10) Pub. No.: US 2016/0149775 A1
(43) Pub. Date: May 26, 2016

(54) DETERMINING PHYSICAL LOCATION OF A NETWORKED COMPUTING DEVICE

(71) Applicant: Dennis Cheung, Sunnyvale, CA (US)

(72) Inventor: Dennis Cheung, Sunnyvale, CA (US)

(21) Appl. No.: 14/551,044

(22) Filed: Nov. 23, 2014

(51) Int. Cl. H04L 12/26; H04L 29/08

(52) U.S. Cl. CPC H04L 43/04; H04L 67/18

(57) ABSTRACT

Techniques for determining location of a networked computing device are presented herein. An association module may be configured to associate two or more co-located computing devices based on an association selected from the group consisting of a common user, network address similarities, local communications between the two or more co-located computing devices, and co-location patterns. A location module may be configured to determine the location for the one of the two or more co-located computing devices, at least in part, based on a location of an associated computing device.

### TECHNICAL FIELD

The subject matter disclosed herein generally relates to the technical field of networked computing devices and more specifically describes determining a physical location of a networked computing device.

### BACKGROUND

As technology advances, consumers use a wide variety of networked computing devices. From desktop computers to mobile devices, users typically access many different devices on a daily basis.

There is a variety of ways to determine a location of computing devices; however, the capability of each device varies in capability and accuracy. Some devices include inherent location capability, such as GPS, or similar. A system may approximate a location of a desktop computer based, at least in part, on a network address for the computer. However, such a machine may use a virtual private network which could alter the network address resulting in an incorrect location.

In another example, a mobile device may include increased location capabilities, however, a mobile device may be more difficult to use because of lower processing power, a smaller screen, a smaller speaker, no physical keyboard, or other limitations.

### BRIEF DESCRIPTION OF THE DRAWINGS

Some embodiments are illustrated by way of example and not limitation in the figures of the accompanying drawings.

FIG. 1 is a block diagram illustrating a system for determining a physical location of a networked computing device, in accordance with an example embodiment.

FIG. 2 is a block diagram illustrating a system for determining a physical location of a networked computing device, in accordance with an example embodiment.

FIG. 3 is a block diagram illustrating a system for determining a physical location of a networked computing device, in accordance with an example embodiment.

FIG. 4 is a block diagram illustrating a system for determining a physical location of a networked computing device, in accordance with an example embodiment.

FIG. 5 is a block diagram illustrating a system for determining a physical location of a networked computing device, in accordance with an example embodiment.

FIG. 6 is an illustration depicting a method for determining a physical location of a networked computing device, in accordance with an example embodiment.

FIG. 7 is an illustration depicting a method for determining a physical location of a networked computing device, in accordance with an example embodiment.

FIG. 8 is an illustration depicting a method for determining a physical location of a networked computing device, in accordance with an example embodiment.

FIG. 9 is an illustration depicting a method for determining a physical location of a networked computing device, in accordance with an example embodiment.

FIG. 10 is an illustration depicting a method for determining a physical location of a networked computing device, in accordance with an example embodiment.

FIG. 11 is an illustration depicting a method for determining a physical location of a networked computing device, in accordance with an example embodiment.

FIG. 12 is a block diagram illustrating components of a machine, according to some example embodiments, able to read instructions from a machine-readable medium and perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Example systems and methods for determining a physical location of a networked computing device are described. In certain embodiments, an association module 120 may associate two or more co-located computing devices. The association module 120 may associate devices used by a common user, have network address similarities, or are located near each other in determinable patterns as will be described.

As described herein, a system and/or computing device may associate two or more client devices. One client device may include limited location capability (e.g. a laptop or a desktop computing device) while the other computing device may include accurate location capabilities (e.g. cellular phone GPS capabilities). In response to laptop device requesting location from a system as described herein, the system may respond with the location of the associated cellular device. Because the cellular device includes more accurate location capabilities, the system may accurately determine the location of the laptop based, at least in part, on the location of the associated cellular device.

A system that associates many computing devices may more accurately determine a location for one of the devices based on a location of another of the associated devices, for example, an associated device with more accurate location capabilities. As described herein, there are many reasons to associate computing devices. Devices associated with a similar user may be associated, devices operating as part of a same local area network (LAN) may be associated, devices that are located according to a determinable pattern may be associated, or other, or the like. The benefits of such association are described in later paragraphs. In a specific example, the user may be shopping, using a laptop computing device, at a networked marketplace for one or more products. A system may desire location information from the laptop in order to recommend products that are physically located near the user. In order to determine a location of the laptop, a system may determine one or more computing devices that are associated with the laptop and may determine an accurate location of an associated computing device that includes accurate location capabilities. The system may then recommend brick and mortar locations for items nearby the user. The determined location may still be accurate although the Internet Protocol (IP) address for the laptop may indicate a different location. For example, the laptop may be using a virtual private network whereby the network address for the virtual private network may indicate a remote physical location that may not truly reflect the physical location of the laptop.

In another example, the cellular device may be located in a structure that may block GPS signals (e.g. in the basement of a large concrete building). Therefore, the cellular device may not be able to determine a physical location. However, the laptop may be connected to a local wireless network in the structure. In this scenario, the system may not be able to determine a location of the cellular device, but will be able to determine the location of the laptop device, based on the network connectivity. Therefore, in response to the cellular device requesting location from the system, the system may determine and respond with the physical location of the associated laptop device.

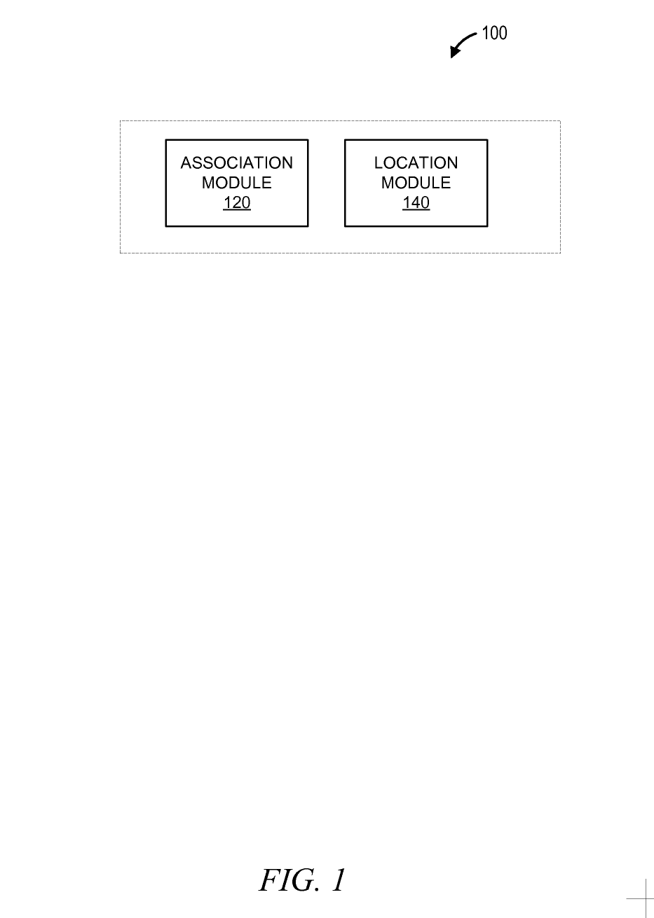

FIG. 1 is a block diagram illustrating a system 100 for determining a physical location of a networked computing device, in accordance with an example embodiment. In one embodiment, the system 102 may include an association module 120 and a location module 140.

In one embodiment, the association module 120 may associate two or more co-located computing devices based on an association selected from the group consisting of a common user, network address similarities, local communications between the two or more co-located computing devices, and co-location patterns.

In one embodiment, co-located means two or more devices that are being used by the same user. In one example, a user may concurrently use a laptop computing device and a cellular device as will be described. In response to the user using the laptop device and the cellular device concurrently, the association module 120 may associate the laptop and the cellular device.

In one embodiment, the association module 120 may receive authentication tokens from the user from two or more different devices. For example, an application on a mobile device may authenticate with the association module 120, and an application executing on the laptop computer may also authenticate with the association module 120. In response to detecting the same user authenticating with the mobile device and the laptop device, the association module 120 may associate the two devices.

In another embodiment, two devices being co-located may mean the two devices operate as part of the same local area network (LAN). In one example, 10 or more devices may operate as part of a local area network in a building. The devices may communicate with the association module 120 such that the association module may determine that the devices are operating as part of the same LAN. The 10 devices may not specifically include location capabilities (e.g. they may be an array of desktop computing devices). A user may bring a new device with enhanced location capabilities and may connect the new device to the network in the building. For example, the user may bring a mobile computing device with GPS location capabilities. In response to receiving communications from the mobile device through the LAN, the association module 120 may associate the mobile computing device. The location module 140 may then query the mobile computing device to determine its location. The association module 120 may further associate the new device with the 10 other devices operating as part of the local network. Therefore, in certain embodiments, the system 102 may determine accurate locations for each of the 10 other devices operating as part of the local network.

Of course, as one skilled in the art may appreciate, a network designer may configure many different networks and may configure different network subnets, routers, switches, or the like. Furthermore, a different network topology may cause a specific local area network to encompass different physical areas. Therefore, co-located may not be limited to any specific geographical limitations, but may be constrained by physical network configurations as opposed to actual spatial boundaries. Furthermore, the association module 120 may disassociate one of the computing devices in response to the computing device being disconnected from the LAN (or connected to a different LAN).

In another embodiment, two or more computing devices may include near field communications, low power radio communications, infrared communications, or other short range communications, or other direct communications not requiring an intermediary signal repeater. In one example, short range communications may include radio based communications with a range of 30 feet or less. Of course, this disclosure is not limited in this regard. The association module 120 may associate two or more devices in response to the devices being within a local communication range.

In one example, a desktop computing device and a mobile computing device may communicate with each other using a wireless signal such as, but not limited to, Bluetooth™. The mobile computing device may communicate with the association module 120 and may report that the desktop computing device is within a local communication range. In response, the association module 120 may associate the desktop computing device with the mobile computing device. This may allow the system 102 to determine a location of the desktop computing device based on the location of the associated mobile computing device. Furthermore, the association module 120 may disassociate one of the computing devices in response to the computing device not being within range of direct communications.

In another embodiment, the association module 120 may associate two devices based on a co-location pattern. In one example, a co-location pattern threshold may be once or more daily for 5 days. In response to the two devices being co-located at least once for each of 5 days, the association module 120 may associate the two devices. Of course, other threshold numbers of days may be used and this disclosure is not limited in this regard.

In another example, the association module 120 may associate two devices based, at least in part, on the two devices being co-located for a total period of time. In one example, a total threshold period of time may be 30 hours. The two devices may be co-located at times, and not co-located at other times. The association module 120 may, based on a report from one of the computing devices, sum time periods when the two devices are co-located. In response to the sum of time exceeding the total threshold period of time, the association module 120 may associate the two computing devices. Of course, the threshold time period may be seconds, minutes, days, weeks, months, years, or other, as one skilled in the art may appreciate.

In another example, the association module 120 may disassociate two or more computing devices in response to a change in a co-location pattern. In one example, a threshold number of times may be daily for 10 days. In response to two devices being co-located at least once a day for 10 days, the association module 120 may associate the two devices. Furthermore, in response to the two devices not being co-located for 10 or more days, the association module 120 may disassociate the two computing devices.

In one embodiment, the system 102 includes the location module 140. The location module 140 may be configured to determine a location for a computing device based on a location of an associated computing device. The location module 140 may perform this determination based, at least in part, on a response from one of the associated computing devices.

In certain example embodiments, the location module 140 may receive location requests from computing devices and may transmit locations to computing devices. These requests and/or transmissions may include a network packet. For example, a client device 110,112 may transmit one or more network packets that include a request for location to the location module 140. In response, the location module 140 may transmit a location to the requesting device 110,112 by transmitting one or more network packets to the client device 110,112. In another example, a client device 110,112 may transmit a location request to the location module 140 by transmitting one or more text messages to the location module 140. Other examples include posting requests via a web page, submitting a request using a network service, transmitting a request via email, transmitting a request via a local wireless signal, displaying a request via a display or other, or the like, as one skilled in the art may appreciate. Therefore, this disclosure is not limited regarding a type or method of receiving a request or transmitting a location.

In another example embodiment, the association module 120 may associate 10 or more computing devices. In response to a location request from one of the 10 computing devices, the location module 140 may request locations from the other 9 computing devices and may perform a wide variety of statistical schemes to determine a location based on responses from the other 9 computing devices. In one example, the location module 140 may determine an average location for the other 9 computing devices. In another example, the location module 140 may determine a median point for a subset of the associated devices. Therefore, in response to the association module 120 associating 10 devices, the location module 140 may determine a location by determining six associated devices that are closest to each other, and determining a median point for six devices.

In another example embodiment, the association module 120 may rank or prioritize location capabilities for associated client devices. For example, the association module 120 may associate a desktop computing device and a cellular computing device. Based on the cellular computing device having more accurate location capabilities as compared with the desktop computing device, the location module 140 may determine a location of the desktop computing device based on the location of the cellular device because the cellular device includes more accurate location capabilities. Therefore, in certain examples, the location module 140 may determine a location of all associated computing devices based on an indicated location of the most accurate associated computing device.

In one example embodiment, the location module 140 may not prioritize location capabilities of associated computing devices and may not consider locations from some of the associated devices. For example, the location module 140 may discard locations from associated devices that are not located nearby other associated devices. For example, where there are four associated devices, one of the associated devices may request a location from the location module 140. The location module 140 may determine locations of the other three of the four devices. In response to two of the three devices being co-located and another of the three devices being at a remote location, the location module 140 may discard the location of the device at a remote location and return the location of the two co-located devices.

In another example, the location module 140 may determine a location based on a majority consensus. For example, in response to five of the 10 associated devices reporting a similar location and four of the 10 associated devices reporting different locations, the location module 140 may report the location of the five because it may represent a majority location of the associated devices.

In another embodiment, the location module 140 may determine a location for a client device 110,112 based, at least in part, on a scheduling application executing on the client device. In one example, the client device 110,112 may include a scheduling application indicating that a user of the computing device may be located at a specific address. For example, the scheduling application may indicate that the user is staying at a specific hotel and the location module 140 may determine a location of the computing device based on an address provided in the scheduling application. In one example, the scheduling application may include a calendar indicating location for a user of the client.

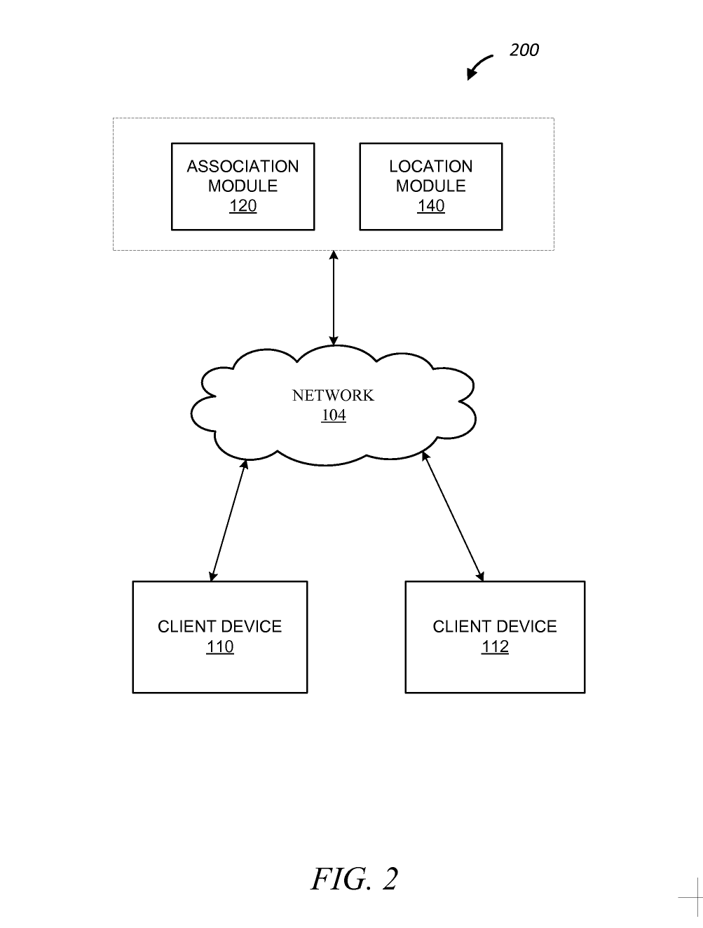

FIG. 2 is a block diagram illustrating a system 200 for determining physical location of a networked computing device, in accordance with an example embodiment. In one example embodiment, the system 200 may include the association module 120, the location module 140, a network 104, a client device 110, and a client device 112. The association module 120 and the location module 140 may or may not be substantially similar to those depicted in FIG. 1.

In one example embodiment, the client device 110 and the client device 112 may include location capabilities that determine location within 50 feet. The association module 120 may request location information from both the client device 110 and the client device 112. The association module 120 may determine that the client device 110 and the client device 112 may be co-located according to a co-location pattern. In one example, a co-location pattern may include the devices 110, 112 being within 50 feet of each other beyond a threshold period of time as previously described. In one example, the client devices 110,112 may be within 50 feet one or more times per day for 30 or more days. Of course, other numbers of days may be used, such as five or less and/or 100 or more days and this disclosure is not limited in this regard. In response, the association module 120 may associate the client devices 110, 112.

In another example, a threshold time may include a total number of hours. A co-location pattern may include the threshold number of hours. For example, a co-location pattern may include client device 110 being co-located with client device 112 for more than 40 hours. In response to the client device 110 and the client device 112 being collocated for more than 40 hours, the association module 120 may associate client device 110 and client device 112. Of course, other values may be used for a number of hours as one skilled in the art may appreciate and this disclosure is not limited in this regard.

In another embodiment, two or more devices may be co-located if they are concurrently on a person. For example, a person may wear a pair of glasses with location capability and a watch with location capability. “On a person” may include a computing device being connected to a person, being carried by a person, being held by a person, or being attached to the person in some other way, as one skilled in the art may appreciate.

In one embodiment, the association module 120 may associate computing devices that are co-located according to a co-location pattern as previously described. In one example, two people may be friends and may be collocated above a threshold time. The association module 120 may associate a computing device for a first friend with a computing device for the second friend. In response to receiving a location request from a computing device for one friend, the location module 140 may return a location for a computing device of another friend. In other examples, client devices 110 and 112 may be associated with spouses, parents and children, business partners, or other social connections, as one skilled in the art may appreciate.

In another embodiment, a child's computing device may be associated with computing devices for friends of the child because they may be co-located beyond a threshold period of time. In one example, the computing device for the child may fail to operate or may fail to provide location information. In response to the computing device for the parent requesting location information for the computing device for the child, the location module 140 may return a location for friends of the child because of associations. Therefore, in certain examples, although a child's computing device may not function, a parent may still receive likely location information based on locations of associated devices.

In another example, a threshold time period may be one second. Therefore, the association module 120 may associate any and/or all devices that are, or have been, co-located with a client device 110, 112 for more than one second. In one example, a client device 110 may fail to operate or provide location information. In response to a location request for the failed client device 110, the location module 140 may return a location for another associated computing device based on the most recent association. This may provide a last known location, or a likely last known device that was within range of the failed client device 110.

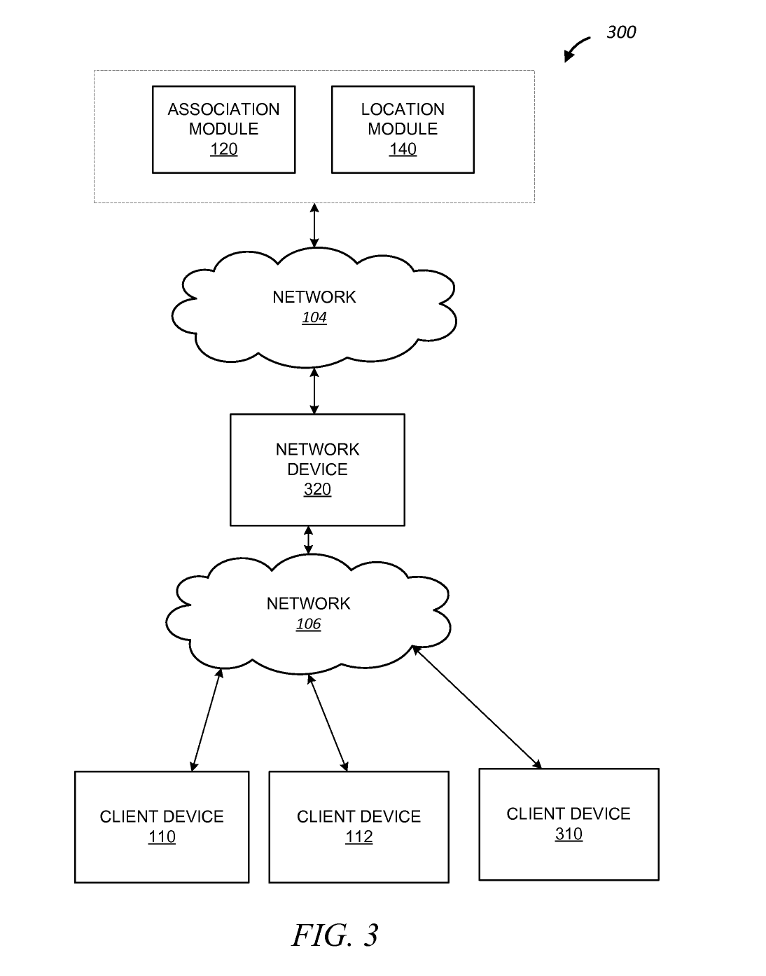

FIG. 3 is a block diagram illustrating a system 300 for determining a physical location of a networked computing device, in accordance with an example embodiment. In one example embodiment, the system 300 may include the association module 120, the location module 140, a network 104, a network 106, a network device 320, a client device 110, a client device 112, and a client device 310. The association module 120, the location module 140, the network 104, the client device 110, and the client device 112 may or may not be substantially similar to those depicted in other figures.

In one embodiment, the association module 120 may associate one or more devices 110, 112, 310 based, at least in part, on network address similarities between the devices. In one example, the network device 320 may be a network router or gateway and may route network traffic between the network 104 and the network 106. The network 106 may be a local area network and the client devices 110, 112, and 310 may have network addresses associated with the local area network 106. For example, the client device 110 may have a network address of 220.0.0.1, the client device 112 may have a network address of 220.0.0.2, and the client device 310 may have a network address 220.0.0.3. The client devices 110, 112, and 310 may have a subnet mask of 255.255.0.0 resulting in a sub-network address of 220.0.

In another example, the client devices 110, 112 and 310 may communicate with the association module 120 and the association module 120 may determine that the client devices 110, 112, and 310 originate from the same local area network. By inspecting network packets from the client devices 110,112,310 the association module 120 may determine that the client devices 110,112,310 have a same sub-network address . . . . The association module 120 may associate the client devices 110, 112, and 310 because of these network address similarities.

In another example, the network device 320 may operate as a name address translation (NAT) device. As one skilled in the art may appreciate, the NAT device may alter originating network address numbers and may replace them with a network address of the network device 320. Therefore, network packets originating from client device 110 may appear as though they originated at network device 320. For example, the client device 112 may have a local network address of 192.168.0.20 at network 106. The NAT device 320 may receive network traffic from network 106 and may have a network address of 230.220.145.6 on the network 104. Network communications received from the client device 110 with the address of 192.168.0.20 will appear, to the association module 120, as if they had originated from the NAT device 320, and will have a source network address of 230.220.145.6. The association module 120 may associate any and/or all client devices 110, 112 that appear to have this address although their actual network addresses on the network 106 may be other addresses.

In one example, the client device 110 and the client device 112 may communicate with the association module 120 in different communication sessions. Although the client devices 110,112 come from the same network address (network device 320), the association module 120 may determine that they are different client devices. In another example, the client devices 110,112 may communicate with the association module 120 using different ports, but from the same network address. The association module 120 may associate the client device 110,112 because they are still communicating using the same network address.

In certain embodiments, a local area network 106 may include one or more devices with increased location capabilities as compared with other computing devices operating as part of the local area network 106. In response to any or the client devices 110, 112 and 310 requesting location information, the location module 140 may return a location of any of the associated computing devices. For example, the location module 120 may return a location of the computing device with the most accurate location capability.

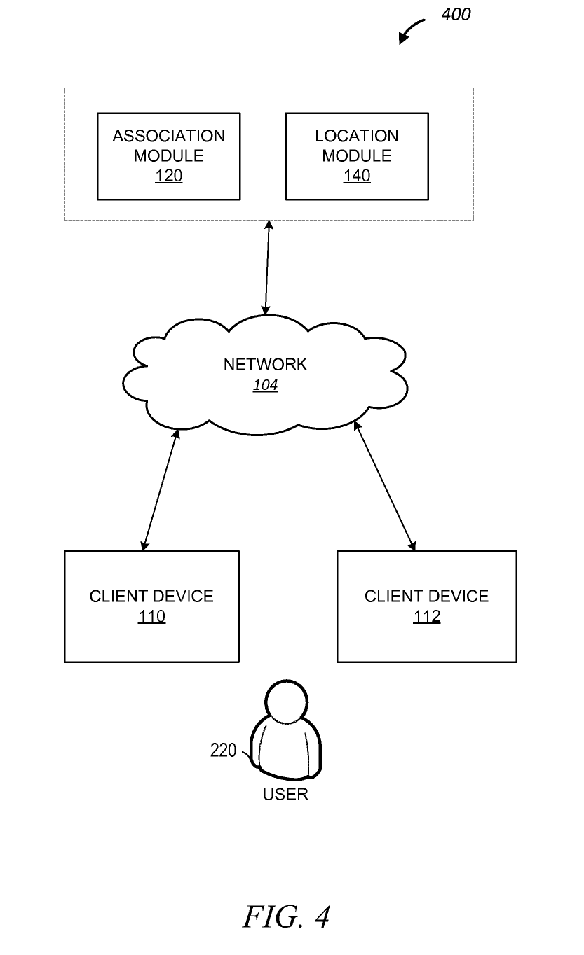

FIG. 4 is a block diagram illustrating a system 400 for determining physical location of a networked computing device, in accordance with an example embodiment. In one embodiment, the system 400 may include the association module 120, the location module 140, a network 104, the client device 110, and the client device 112. The association module 120, the location module 140, the network 104, the client device 110 and the client device 112 may or may not be substantially similar those depicted in other figures.

In one embodiment, a user 220 of the client device 110 may authenticate with the association module 120 over the network 104. In one example, the network 104 may be the Internet. Of course, this is not necessarily the case as the network 104 may be any network as described herein, or another network. The same user 220 may also authenticate with the association module 120 via the client device 112. In one example, the client device 110 is a desktop computer and the client device 112 is a mobile computer. In response to the association module 120 receiving authentication tokens from the user 220 from both the client device 110 and the client device 112, the association module 120 may associate the client device 110 and the client device 112. Therefore, because there is a common user 220 associated with the client device 110 and the client device 112, the association module 120 may associate the devices 110, 112. In one example embodiment, in response to the desktop computer client device 110 requesting location information, the location module 140 may return a location of the mobile computer client device 112.

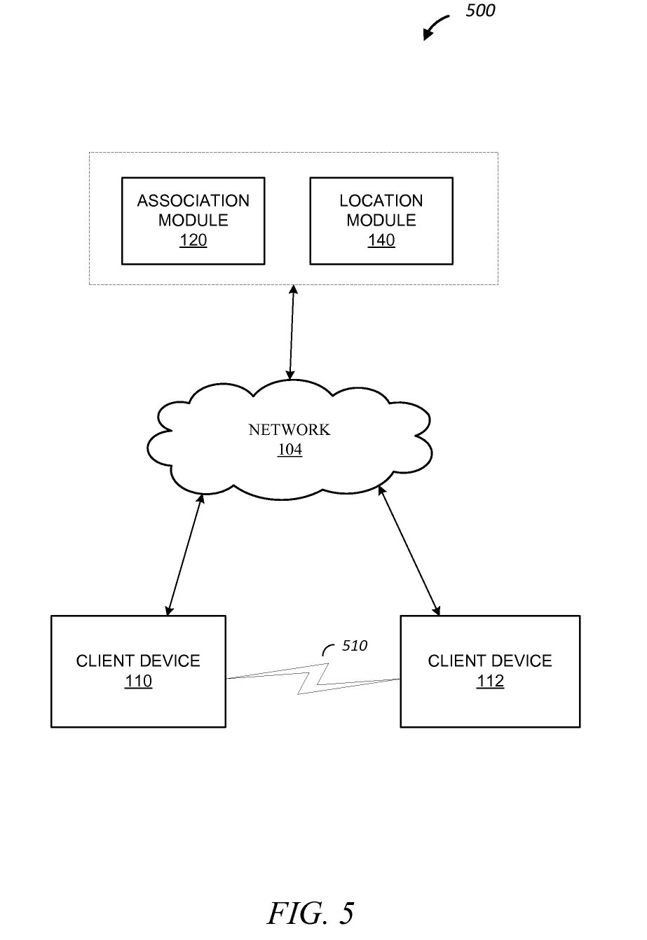

FIG. 5 is a block diagram illustrating a system 500 for determining a physical location of a networked computing device, in accordance with an example embodiment. In one embodiment, the system may include the association module 120, the location module 140, a network 104, the client device 110, and the client device 112. The association module 120, the location module 140, the network 104, the client device 110 and the client device 112 may or may not be substantially similar those depicted in other figures.

In one example embodiment, the client device 110 and the client device 112 may communicate with each other using a wireless connection 510. The wireless connection 510 may include any available, or to be developed, wireless connection, as one skilled in the art may appreciate. In one example, the wireless connection 510 may be Bluetooth™. Because the client device 110 may detect Bluetooth™ connectivity with the client device 112, the association module 120 may associate the client device 110 and the client device 112. For example, the client device 110 may detect the client device 112 and may transmit one or more messages to the association module 120 to indicate that the client device 112 is within a local communication range, such as, but not limited to, a range within the capabilities of the wireless connection 510. In one example embodiment, the client device 112 may request location information from the location module 140 and the location module 140 may respond with location information for the client device 110, or other location as described herein.

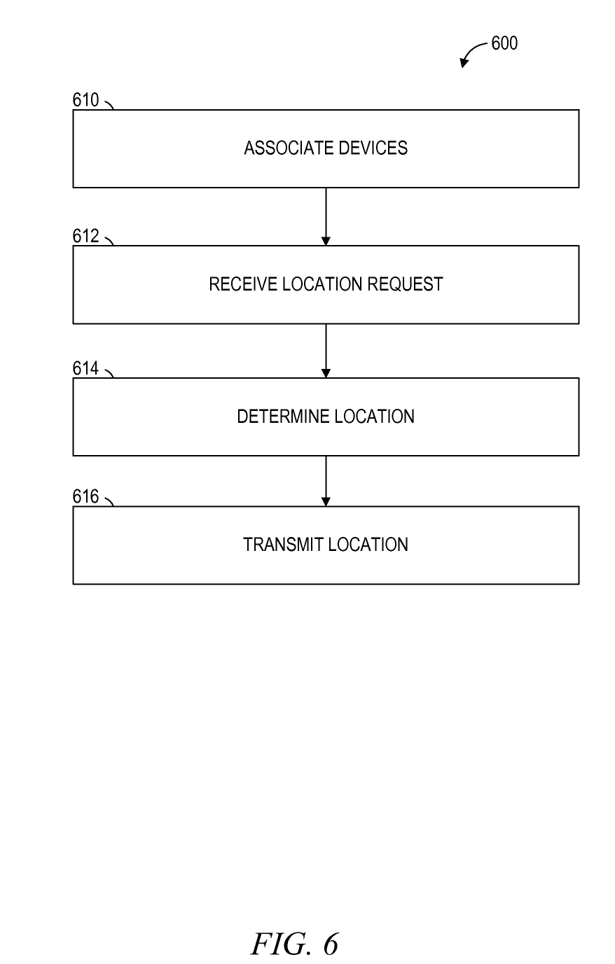

FIG. 6 is an illustration depicting a method 600 for determining a physical location of a networked computing device, in accordance with an example embodiment. Operations in the method 600 may be performed by the system 102, using modules described above with respect to FIG. 1-5. As shown in FIG. 6, the method 600 includes operations 610, 612, 614, and 616.

In one embodiment, the method 600 may begin and at operation 610 the association module 120 may associate two or more co-located client devices 110, 112. As described herein, the association may be based on a common user 220, network address similarities, local communications, co-location patterns, or the like. The method 600 may continue at operation 612 and the location module 140 may receive a location request from an associated computing device. The method may continue at operation 614 and the location module 140 may determine a location based, at least in part, on locations of computing devices that are associated with the associated computing device as described herein. The location module 140, may then, at operation 616, transmit the determined location to an associated computing device that issued the location request and the method 600 may end.

In one example, several client devices may communicate with the association module 120 from a same local area network (as indicated by the client devices having similar network addresses) and the operation 610 may include the association module 610 associating two or more of the several client devices because of the network address similarities. At operation 612, the location module 140 may receive a location request from one of the associated client devices. The association module 120 may transmit a list of client devices that are associated with client device requesting location information. The location module 140 may then determine a location based, at least in part, on the locations of the associated client devices.

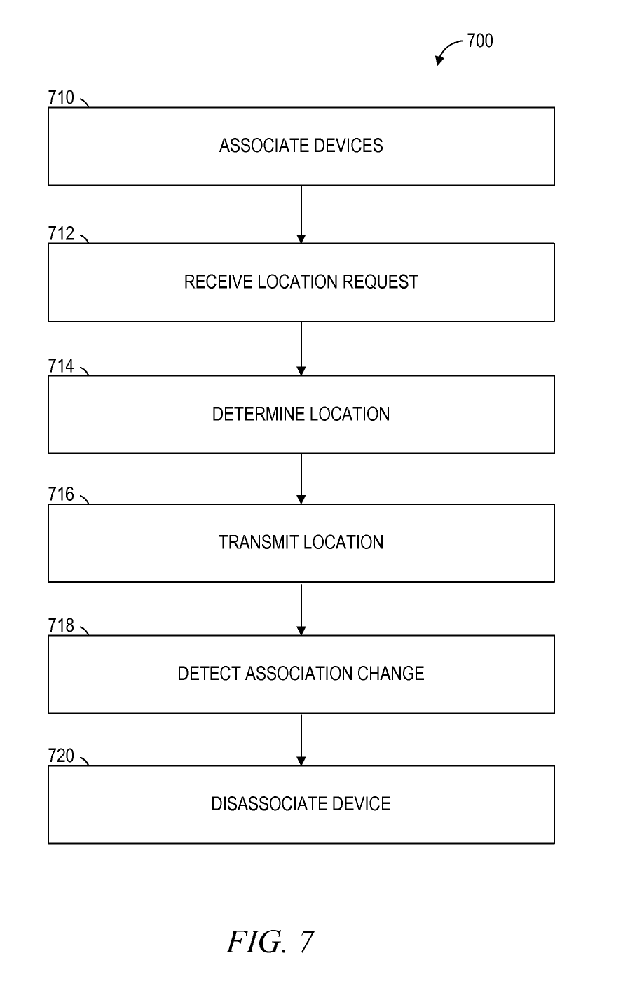

FIG. 7 is an illustration depicting a method 700 for determining a physical location of a networked computing device, in accordance with an example embodiment. Operations in the method 700 may be performed by the system 102, using modules described above with respect to FIG. 1-5. As shown in FIG. 7, the method 700 includes operations 710, 712, 714, 716, 718, and 720.

In one embodiment, the method 700 may begin and at operation 710 the association module 120 may associate two or more co-located devices. At operation 712, the location module 140 may receive a location request from one of the associated devices. The method 700 may continue at operation 714 and the location module 140 may determine a location as described herein. In one example, a location may include a location of a different associated device. In another example, the location module 140 may determine a location based, at least in part, on two or more locations of other associated devices. The method 700 may continue at operation 716 and the location module 140 may transmit the determined location to the computing device that requested the location.

The method may continue at operation 718 and the association module 120 may detect a change in an association between two or more co-located computing devices.

In one example, a user may have authenticated with the association module 120 using a client device 110 in a consistent pattern, for example, daily. In response to the user not authenticating with the association module 120 for many days, for example, the association module 120 may disassociate the client device 110 with other client devices that were associated with the client devices based on a common user.

In another example, a client device 110 may have been associated with another client device 112 based on a common network address. In response to a client device 110 communicating with the association module 120 from a different network address (and a network address that is different from the client device 112), the association module 120 may disassociate the client device 110 from the client device 112.

In one example, a client device 110 may have been associated with another client device 112 because the client devices 110,112 were within a local communication range. In response to the client devices 110,112 not being within a local communication range for a period of time, many days for example, the association module 120 may disassociate the client devices 110,112.

In certain examples, the detected change may include a change in a co-location pattern between client devices 110,112. In response to a change in an association between two or more computing devices, the method may continue at operation 720 and the association module 120 may disassociate one or more computing devices.

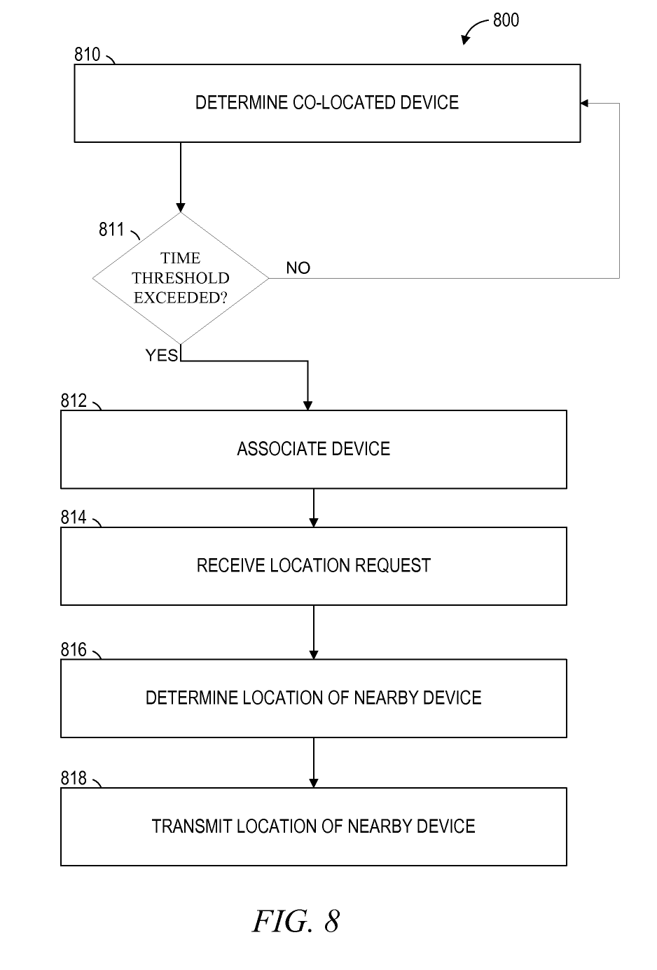

FIG. 8 is an illustration depicting a method 800 for determining a physical location of a networked computing device, in accordance with an example embodiment. Operations in the method 800 may be performed by the system 102, using modules described above with respect to FIG. 1-5. As shown in FIG. 8, the method 800 includes operations 810, 811, 812, 814, 816, and 818.

In one embodiment, the method 800 may begin and the association module 120 may determine that a second computing device is co-located with a first computing device. The method 800 may continue at operation 811 and the association module 120 may determine whether a co-location time threshold has been exceeded. As described herein, a time threshold may include a threshold number of days when the first computing device and the second computing device are co-located at least a portion of the day. In another example, a time threshold may include a total amount of time, such as, but not limited to, a number of hours. In response to the time threshold not being exceeded, the method 800 may continue at operation 810.

In response to the time threshold time being exceeded, the method 800 may continue at operation 812 and the association module 120 may associate the first computing device and the second computing device because they have been co-located beyond a threshold time. In one example, the threshold time may be a threshold time period. In another example, the threshold time may include a threshold number of times.

The method 800 may continue at operation 814 and the location module 140 may receive a location request from an associated computing device. The method may continue at operation 816 and the location module 140 may determine a location based, at least in part, on a location of an associated computing device as described herein. The method 800 may continue at operation 818 and the location module 140 may transmit the determined location to the computing device that requested the location.

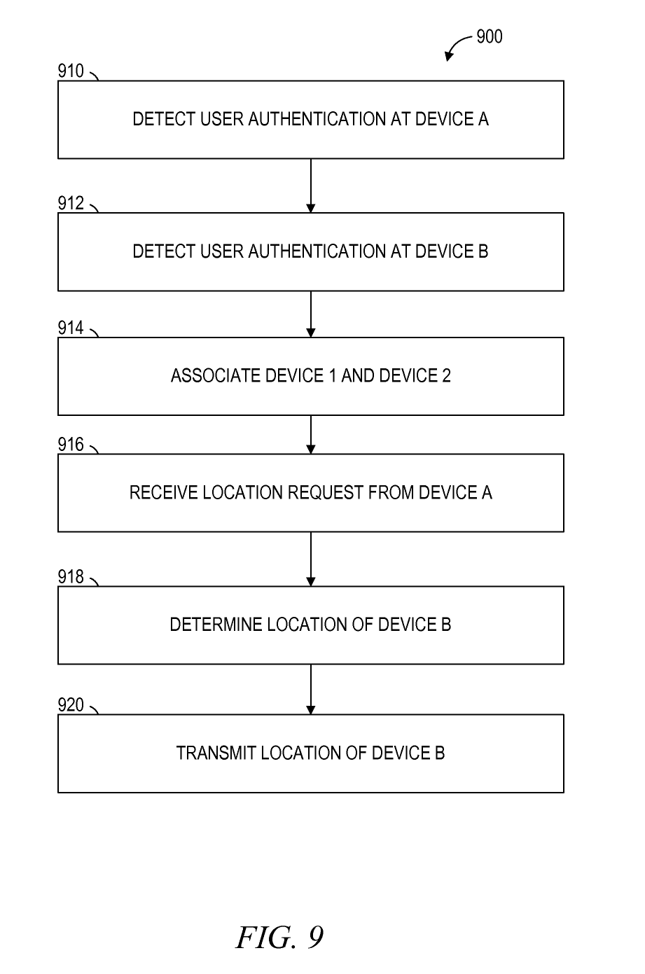

FIG. 9 is an illustration depicting a method for determining a physical location of a networked computing device, in accordance with an example embodiment. Operations in the method 900 may be performed by the system 102, using modules described above with respect to FIG. 1-5. As shown in FIG. 9, the method 900 includes operations 910, 912, 914, 916, 918, and 920.

In one example embodiment, the method 900 may begin at operation 910 and the association module 120 may detect a user 220 authenticating using a computing device A. The method 900 may continue at operation 912 and the association module 120 may detect the user 220 authenticating using a computing device B. The method 900 may continue at operation 914 and the association module 120 may associate device A and device B based on the common user 220 authenticating. In one example, the association module may associate device A and device B in response to the user authenticating with the devices according to a pattern. For example, where a user authenticates using device A and device B at least once per day for a threshold number of days.

The method 900 may continue at operation 916 and the location module 140 may receive a location request from device A. The method 900 may continue at operation 918 and the location module 140 may determine the location of device B. The method may continue at operation 920 and the location module 140 may transmit the location of device B as the location of device A and the method 900 may end.

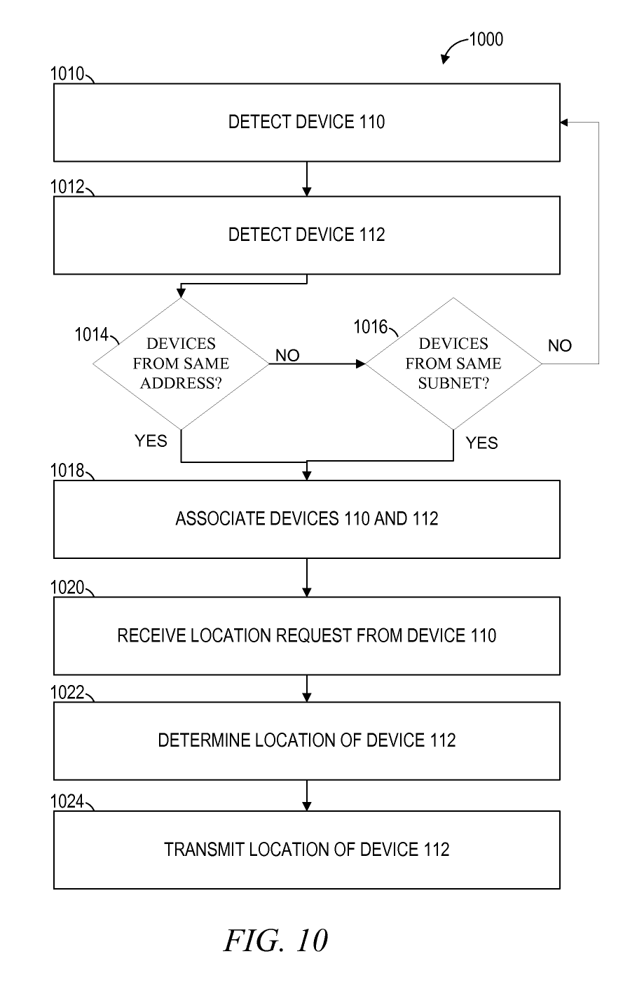

FIG. 10 is an illustration depicting a method 1000 for determining a physical location of a networked computing device, in accordance with an example embodiment. Operations in the method 1000 may be performed by the system 102, using modules described above with respect to FIG. 1-5. As shown in FIG. 10, the method 1000 includes operations 1010, 1012, 1014, 1016, 1018, 1020, 1022, and 1024.

In one example embodiment, the method 1000 may begin at operation 1010 and the association module 120 may detect network communications from device 110. The association module 120 may track, log, store, or the like, network addresses for computing devices that communicate with the association module 120. The method 1000 may continue at operation 1012 and the association module 120 may detect network communications from device 112. The method may continue at operation 1014 and the association module 120 may determine whether network communications from device 110 and from device 112 originated from the same network address. In response to the devices not originating from the same network address, the method 1000 may continue at operation 1016 and the association module 120 may determine whether the devices 110, 112 operate on the same sub-network. In response to the association module 120 determining that the devices 110, 112 do not originate from the same sub-network, the method 1000 may continue at operation 1010.

In response to the devices 110, 112 originating from the same network address, the method 1000 may continue at operation 1018 and the association module 120 may associate the device 110 and the device 112. In response to the association module 120 determining that the devices 110, 112 originate from the same sub-network, the method 1000 may continue at operation 1018 and the association module 120 may associate the device 110 and the device 112. The method 1000 may continue at operation 1020 and the location module 140 may receive a location request for device 110. The method 1000 may continue at operation 1022 and the location module 140 may determine the location of device 112. The method 1000 may continue at operation 1024 and the location module 140 may transmit the location of device 112 to device 110 because the device 110 had requested the location.

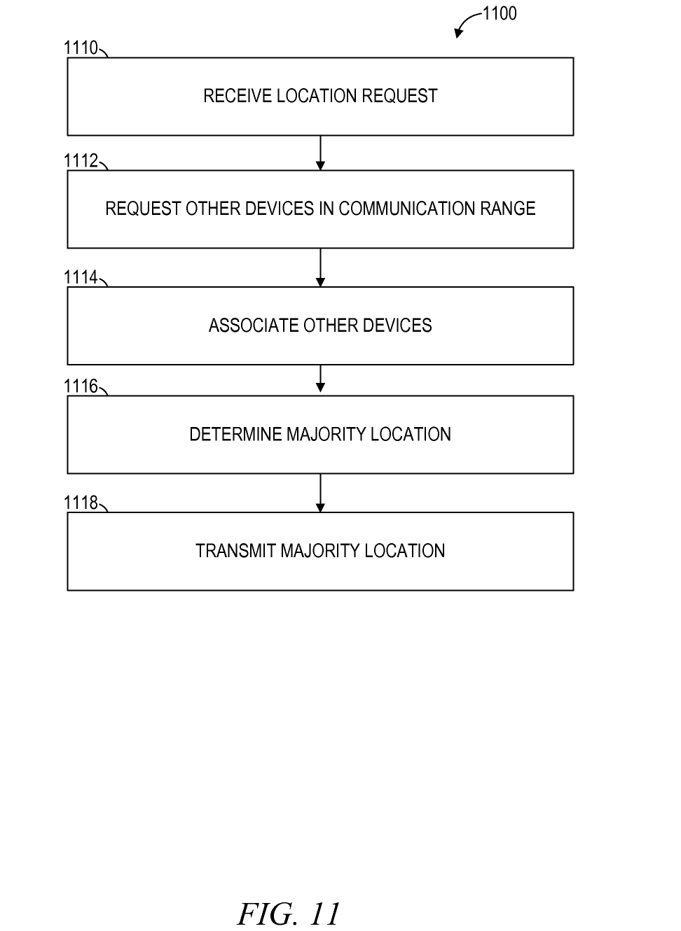

FIG. 11 is an illustration depicting a method for determining a physical location of a networked computing device, in accordance with an example embodiment. Operation 1100 may be performed by the system 102, using modules described above with respect to FIG. 1-5. As shown in FIG. 11, the method 1100 includes operations 1110, 1112, 1114, 1116, and 1118.

In one example embodiment of the method 1100, the method 1100 may begin and the location module 140 may receive a location request from a computing device. The method 1100 may continue at operation 1112 and the location module 140 may request the computing device to identify other devices in a local communication range of the computing device. In response to receiving identification of other devices within a local communication range of the computing device, the association module 120 may associate other devices with the computing device. The method 1100 may continue at operation 1116 and the location module 140 may determine the majority location of the other devices. The method 1100 may continue at operation 1118 and the location module 140 may transmit the determined location to the computing device and method 1100 may end.

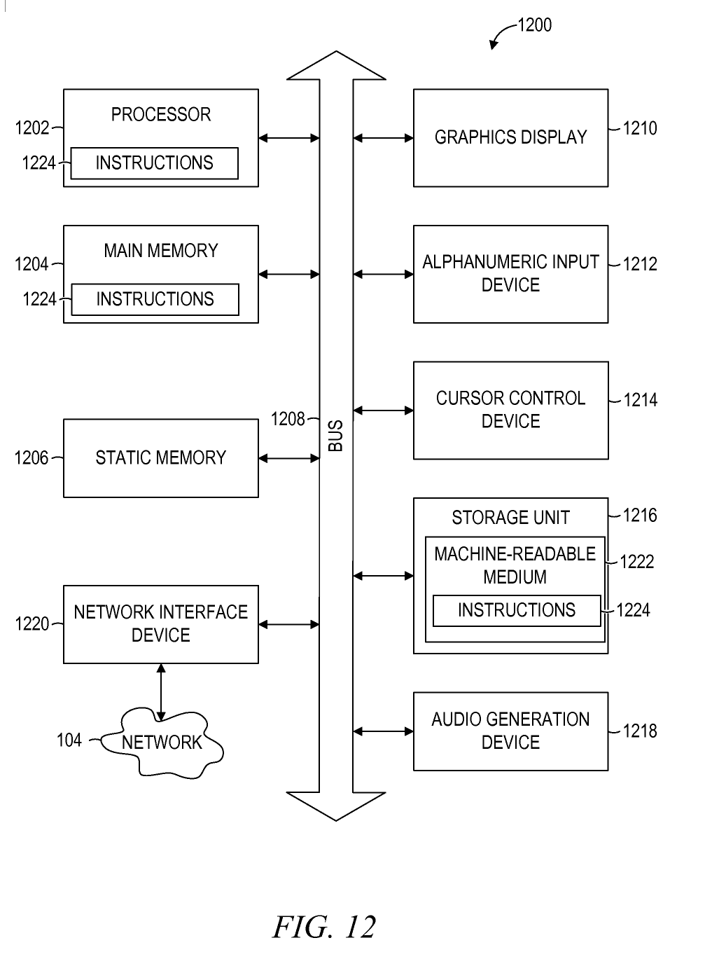

FIG. 12 is a block diagram illustrating components of a machine 1200, according to some example embodiments, able to read instructions 1224 from a machine-readable medium 1222 (e.g., any of a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part. In one example embodiment, the association module 120 and the location module 140 may be included in the instructions 1224.

In alternative embodiments, the machine 1200 may operate as a standalone device or may be connected (e.g., networked) to other machines. The association module 120 and the location module 140 may operate via the machine 1200. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by that machine. Further, while only a single machine is illustrated, the term “machine” shall also be taken to include any collection of machines that individually or jointly execute the instructions 1224 to perform all or part of any one or more of the methodologies discussed herein. Therefore, in certain embodiments, the various modules described herein, may be executed on different machines operating as part of the system 102.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a graphics display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, an audio generation device 1218 (e.g., a sound card, an amplifier, a speaker, a headphone jack, or any suitable combination thereof), and a network interface device 1220.

The storage unit 1216 includes the machine-readable medium 1222 on which are stored the instructions 1224 embodying any one or more of the methodologies or functions described herein. The instructions 1224 may also reside, completely or at least partially, within the main memory 1204, within the processor 1202 (e.g., within the processor's cache memory), or both, before or during execution thereof by the machine 1200. Accordingly, the main memory 1204 and the processor 1202 may be considered machine-readable media 1222 (e.g., tangible and non-transitory machine-readable media). The instructions 1224 may be transmitted or received over the network 1120 via the network interface device 1220. For example, the network interface device 1220 may communicate the instructions 1224 using any one or more transfer protocols (e.g., hypertext transfer protocol (HTTP)).

In some example embodiments, the machine 1200 may be a portable computing device, such as a smart phone or tablet computer. Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network 104 (e.g., the Internet) and via one or more appropriate interfaces (e.g., an application program interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non exclusive “or,” unless specifically stated otherwise.

What is claimed is:

1. A computer system comprising:
a processor;
a memory device holding an instruction set executable on the processor to cause the computer system to perform operations comprising:
associating two or more co-located computing devices based on an association selected from the group consisting of a common user, network address similarities, local communications between the two or more co-located computing devices, and co-location patterns;
receiving a request for a location from one of the two or more co-located computing devices;
determining the location for the one of the two or more co-located computing devices in response to receiving the request, the location based on a location of one or more associated computing devices; and
transmitting the location to the one of the two or more co-located computing devices.

2. The computer system as in claim 1, wherein associating based on a common user comprises determining that the user has authenticated with the two or more co-located computing devices.

3. The computer system as in claim 1, wherein associating based on network address similarities comprises at least one of associating devices having a same subnet network address, or associating devices communicating through a same network device.

4. The computer system as in claim 1, wherein associating based on co-location patterns comprises associating devices that are co-located beyond at least one of a threshold number of times or a threshold time period.

5. The computer system as in claim 1, wherein the operations further comprise disassociating at least one of the two or more co-located computing devices in response to a change in the association.

6. The computer system as in claim 1, wherein determining the location for the one of the two or more co-located computing devices comprises determining the location based on location similarities between a majority of the two or more associated computing devices.

7. The computer system as in claim 1, wherein the location is further based on location information stored in a scheduling application executing on the associated computing device.

8. A computer-implemented method comprising:
associating two or more co-located computing devices based on an association selected from the group consisting of a common user, network address similarities, local communications between the two or more co-located computing devices, and co-location patterns;
receiving a request for a location from one of the two or more co-located computing devices;
determining the location for the one of the two or more co-located computing devices in response to receiving the request, the location based on a location of one or more associated computing devices; and
transmitting the location to the one of the two or more co-located computing devices.

9. The computer-implemented method as in claim 8, wherein associating based on a common user comprises determining that the user has authenticated with the two or more co-located computing devices.

10. The computer-implemented method as in claim 8, wherein associating based on network address similarities comprises at least one of associating devices having a same subnet network address, or associating devices communicating through a same network device.

11. The computer-implemented method as in claim 8, wherein associating based on co-location patterns comprises associating devices that are co-located beyond at least one of a threshold number of times or a threshold time period.

12. The computer-implemented method as in claim 8, further comprising disassociating at least one of the two or more co-located computing devices in response to a change in the association.

13. The computer-implemented method as in claim 8, wherein determining the location for the one of the two or more co-located computing devices comprises determining the location based on location similarities between a majority of the two or more associated computing devices.

14. The computer-implemented method as in claim 8, wherein the location is further based on location information stored in a scheduling application executing on the associated computing device.

15. A machine-readable medium storing executable instructions thereon, which, when executed by a processor, cause the processor to perform operations including:
associating two or more co-located computing devices based on an association selected from the group consisting of a common user, network address similarities, local communications between the two or more co-located computing devices, and co-location patterns;
receiving a request for a location from one of the two or more co-located computing devices;
determining the location for the one of the two or more co-located computing devices in response to receiving the request, the location based on a location of one or more associated computing devices; and
transmitting the location to the one of the two or more co-located computing devices.

16. The machine-readable medium as in claim 15, wherein associating based on a common user comprises determining that the user has authenticated with the two or more co-located computing devices.

17. The machine-readable medium as in claim 15, wherein associating based on network address similarities comprises at least one of associating devices having a same subnet network address, or associating devices communicating through a same network device.

18. The machine-readable medium as in claim 15, wherein associating based on co-location patterns comprises associating devices that are co-located beyond at least one of a threshold number of times or a threshold time period.

19. The machine-readable medium as in claim 15, wherein the operations further comprise disassociating at least one of the two or more co-located computing devices in response to a change in the association.

20. The machine-readable medium as in claim 15, wherein determining the location for the one of the two or more co-located computing devices comprises determining the location based on location similarities between a majority of the two or more associated computing devices.
